(19) United States
(12) Patent Application Publication
(10) Pub. No.: US 2024/0281771 A1
(43) Pub. Date: Aug. 22, 2024

(54) COMPUTER

(71) Applicant: TOYOTA JIDOSHA KABUSHIKI KAISHA, Toyota-shi (JP)

(72) Inventors: Wataru MIZUTANI, Miyoshi-shi (JP); Kyosuke MATSUMOTO, Miyoshi-shi (JP); Yohei NAKANISHI, Nagoya-shi (JP)

(73) Assignee: TOYOTA JIDOSHA KABUSHIKI KAISHA, Toyota-shi (JP)

(21) Appl. No.: 18/423,739

(22) Filed: Jan. 26, 2024

(30) Foreign Application Priority Data
Feb. 17, 2023 (JP) 2023-023855

(51) Int. Cl. G06Q 10/20; G07C 5/08

(52) U.S. Cl. CPC G06Q 10/20; G07C 5/0808

(57) ABSTRACT

A computer according to the present disclosure includes a controller configured to acquire requests to exchange components of vehicles, acquire degree of deterioration of the components with which the vehicles are equipped, select a pair of vehicles whose components are to be exchanged based on the requests, and determine second parts to be exchanged in the pair among first parts composing the components based on the degree of deterioration.

### CROSS-REFERENCE TO RELATED APPLICATION

This application claims priority to Japanese Patent Application No. 2023-023855, filed on Feb. 17, 2023, the entire contents of which are incorporated herein by reference.

### TECHNICAL FIELD

The present disclosure relates to a computer.

### BACKGROUND

In recent years, services for matching users who wish to exchange components of vehicles with each other are known. For example, Patent Literature (PTL) 1 discloses a technology for reserving a work facility to exchange components of vehicles between a user who wishes to sell and another user who wishes to buy.

### CITATION LIST

### Patent Literature

PTL 1: JP 2022-180235 A

### SUMMARY

There is a need to further improve the usefulness of the services for matching users who wish to exchange components of vehicles with each other. For example, it is demanded, when matching users whose components are to be exchanged, to reduce a feeling of unfairness between the users.

It would be helpful to improve the usefulness of a service for matching users who wish to exchange components of vehicles with each other.

A computer according to an embodiment of the present disclosure includes a controller configured to:

acquire requests to exchange components of vehicles;

acquire degree of deterioration of the components with which the vehicles are equipped;

select a pair of vehicles whose components are to be exchanged based on the requests; and

determine second parts to be exchanged in the pair among first parts composing the components based on the degree of deterioration.

According to an embodiment of the present disclosure, the usefulness of a service for matching users who wish to exchange components of vehicles with each other can be improved.

### BRIEF DESCRIPTION OF THE DRAWINGS

In the accompanying drawings:

FIG. 1 is a block diagram illustrating a schematic configuration of a vehicle matching system according to an embodiment of the present disclosure;

FIG. 2 is a block diagram illustrating a schematic configuration of a vehicle;

FIG. 3 is a block diagram illustrating a schematic configuration of a server;

FIG. 4 is a flowchart illustrating an operation example of the vehicle matching system; and

FIG. 5 is a table illustrating an example of degree of deterioration of components of vehicles.

### DETAILED DESCRIPTION

Hereinafter, an embodiment of the present disclosure will be described.

### Outline of Embodiment

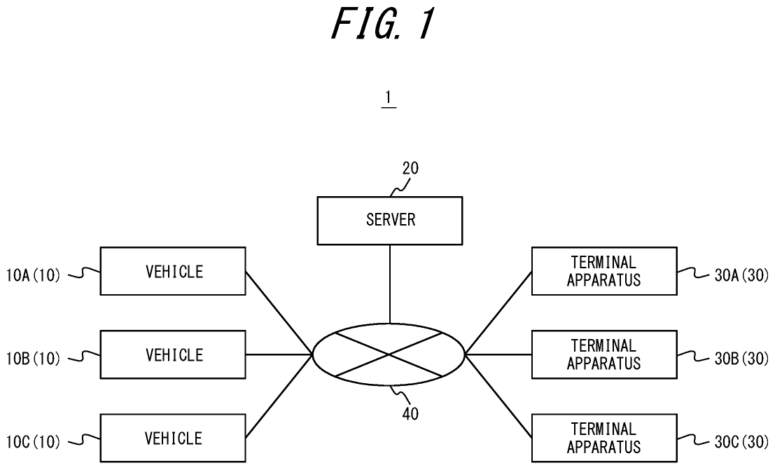

With reference to FIG. 1, an outline of a vehicle matching system 1 according to an embodiment of the present disclosure will be described. FIG. 1 is a block diagram illustrating a schematic configuration of the vehicle matching system 1. The vehicle matching system 1 includes vehicles 10A, 10B, and 10C, a server 20, and terminal apparatuses 30A, 30B, and 30C.

The vehicles 10A, 10B, and 10C are any vehicle, such as passenger cars, buses, trucks, or motorcycles. Hereinafter, the vehicles 10A, 10B, 10C are collectively referred to simply as the vehicle 10 when no distinction therebetween is made. In this disclosure, the vehicle 10 includes one or more components that are exchangeable with other vehicle 10. The components are, for example, headlamps, but are not limited thereto.

The server 20 is configured by one or more computers. In the present embodiment, the server 20 will be described as being configured by a single computer. However, the server 20 may be configured by multiple computers that can communicate with each other, such as a cloud computing system.

The terminal apparatuses 30A, 30B, and 30C are, for example, personal computers, but are not limited thereto and may be any computer, such as smartphones or tablets. In this disclosure, the terminal apparatus 30A shall be a terminal apparatus installed in an automobile dealer or the like that sells, maintains, or inspects the vehicle 10A or the components of the vehicle 10A. The terminal apparatus 30B shall be a terminal apparatus installed in an automobile dealer that sells, maintains, or inspects the vehicle 10B or the components of the vehicle 10B, and the terminal apparatus 30C shall be a terminal apparatus installed in an automobile dealer that sells, maintains, or inspects the vehicle 10C or the components of the vehicle 10C. However, the terminal apparatuses 30A-30C are not limited to terminal apparatuses installed at automobile dealers, but may be, for example, terminal apparatuses owned by the owners of the vehicles 10A-10C respectively. Hereinafter, the terminal apparatuses 30A, 30B, and 30C are collectively referred to simply as the terminal apparatus 30 when no distinction therebetween is made.

For the sake of simplicity, FIG. 1 illustrates three each of the vehicle 10 and the terminal apparatus 30, and one server 20. However, the vehicle matching system 1 may include any number of vehicles 10, servers 20, and terminal apparatuses 30. The vehicle 10, the server 20, and the terminal apparatus 30 are communicably connected to a network 40 including, for example, the Internet, a mobile communication network, or the like.

First, an outline of the present embodiment will be described, and details thereof will be described later. The vehicle matching system 1 is used, for example, to provide a vehicle matching service that matches users who wish to exchange components of the vehicles 10. The user is, for example, the owner of the vehicle 10, an employee of the automobile dealer of the vehicle 10, etc. The server 20 acquires requests to exchange components of the vehicle 10, as well as the degree of deterioration of the components with which the vehicle 10 is equipped. The server 20 selects a pair of vehicles 10 to exchange components based on the requests. The server 20 determines the second parts to be exchanged in the pair of the vehicles 10 among the first parts composing the components based on the degree of deterioration mentioned above.

Thus, according to the present embodiment, when matching users who wish to exchange components of the vehicle 10, the present embodiment determines which of the parts that compose the components are to be exchanged by considering the degree of deterioration of the components with which respective vehicles 10 are equipped. This reduces the sense of unfairness and, in turn, improves the degree of success of matching. Thus, the present embodiment improves the usefulness of the service for matching users who wish to exchange components of the vehicle 10 with each other.

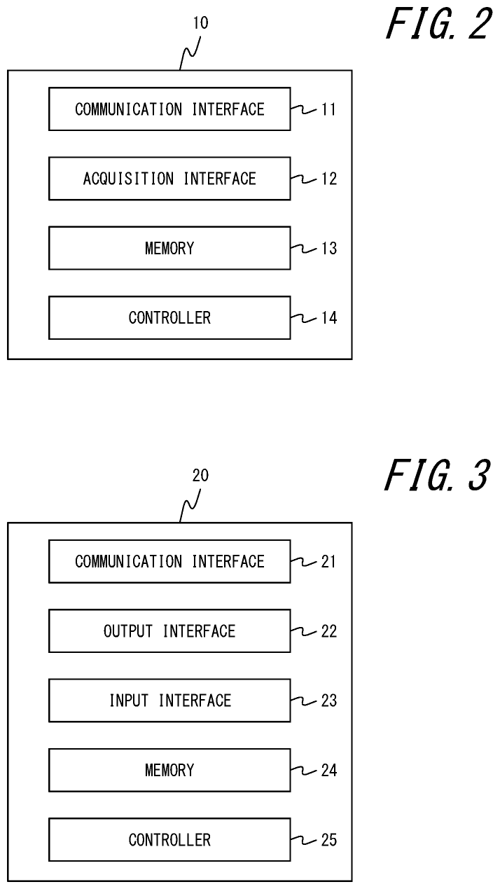

Next, with reference to FIGS. 2 and 3, configurations of the vehicle matching system 1 will be described in detail. FIG. 2 is a block diagram illustrating a schematic configuration of the vehicle 10. FIG. 3 is a block diagram illustrating a schematic configuration of the server 20.

### Configuration of Vehicle

As illustrated in FIG. 2, the vehicle 10 includes a communication interface 11, an acquisition interface 12, a memory 13, and a controller 14. The communication interface 11, the acquisition interface 12, the memory 13, and the controller 14 are, for example, communicably connected via an in-vehicle network, such as a Controller Area Network (CAN), or a dedicated line so as to communicate with each other.

The communication interface 11 includes a communication module for connecting to the network 40. The communication module is, for example, a communication module compliant with a mobile communication standard such as the 4th Generation (4G) standard or the 5th Generation (5G) standard. The communication module may be, for example, a communication module compliant with a standard such as a wired Local Area Network (LAN) standard or a wireless LAN standard. The communication module may be a communication module compliant with a short-range wireless communication standard such as Wi-Fi® (Wi-Fi is a registered trademark in Japan, other countries, or both), Bluetooth® (Bluetooth is a registered trademark in Japan, other countries, or both), or an infrared communication standard. In the present embodiment, the vehicle 10 is connected to the network 40 via the communication interface 11. This enables the vehicle 10 to communicate with the server 20 or the like.

The acquisition interface 12 includes at least one sensor or measurement device. The acquisition interface 12 acquires information on the degree of deterioration of the components with which the vehicle 10 is equipped. The sensors or the measurement devices include, but are not limited to, speed sensors, acceleration sensors, integrated odometers, voltmeters, ammeters, illumination sensors, displacement sensors, contact sensors, image sensors, or infrared sensors.

For example, if the components of the vehicle 10 to be exchanged in the vehicle matching system 1 are the headlamps, the acquisition interface 12 may acquire information such as the number of times the headlamps are turned on and off, the illuminance level of the headlamp lights, or the total accumulated mileage of the vehicle 10 as the degree of deterioration of the headlamps.

The memory 13 is, for example, a semiconductor memory, a magnetic memory, an optical memory, or the like. The memory 13 may function as, for example, a main memory, an auxiliary memory, or a cache memory. The memory 13 stores any information to be used for operations of the vehicle 10. For example, the memory 13 stores a system program, an application program, embedded software, or the like. The information stored in the memory 13 may be updated with, for example, information acquired from the network 40 via the communication interface 11.

The controller 14 includes at least one processor. The processor may be, for example, a general purpose processor such as a Central Processing Unit (CPU), a dedicated processor that is dedicated to specific processing, or the like. The controller 14 is not limited to a processor and may include at least one dedicated circuit. The dedicated circuit may be, for example, a Field-Programmable Gate Array (FPGA) or an Application Specific Integrated Circuit (ASIC). The controller 14 controls the components such as the communication interface 11, the acquisition interface 12, and the memory 13 that are described above in order to realize the functions of the vehicle 10, including the functions of the components. The controller 14 may be, for example, a computer for the vehicle 10, such as an Autonomous Driving System (ADS), Advanced Driver Assistance Systems (ADAS), an Electronic Control Unit (ECU), or a car navigation system.

### Configuration of Server

As illustrated in FIG. 3, the server 20 includes a communication interface 21, an output interface 22, an input interface 23, a memory 24, and a controller 25. The communication interface 21, the output interface 22, the input interface 23, the memory 24, and the controller 25 are communicably connected to each other in a wired or wireless manner.

The communication interface 21 includes a communication module for connecting to the network 40. The communication module is, for example, a communication module compliant with a mobile communication standard such as the 4G standard or the 5G standard. The communication module may be, for example, a communication module compliant with a standard such as a wired LAN standard or a wireless LAN standard. The communication module may be a communication module compliant with a short-range wireless communication standard such as Wi-Fi, Bluetooth, or an infrared communication standard. In the present embodiment, the server 20 is connected to the network 40 via the communication interface 21. This enables the server 20 to communicate with the vehicle 10, the terminal apparatus 30, and the like.

The output interface 22 includes at least one output apparatus. The output apparatus is, for example, a display, a speaker, a lamp, or the like. The output interface 22 outputs images, sound, light, or the like.

The input interface 23 includes at least one input apparatus. The input apparatus is, for example, a touch panel, a camera, a lever, a button, or the like. The input interface 23 accepts input operations from a user.

The memory 24 is, for example, a semiconductor memory, a magnetic memory, an optical memory, or the like. The memory 24 may function as, for example, a main memory, an auxiliary memory, or a cache memory. The memory 24 stores any information used for operations of the server 20. For example, the memory 24 stores a system program, an application program, embedded software, or the like. The information stored in the memory 24 may be updated with, for example, information acquired from the network 40 via the communication interface 21.

The memory 24 may store information on the vehicle 10. The information about the vehicle 10 includes, for example, information that can identify the vehicle 10, information that can identify components with which the vehicle 10 is equipped, or information about the owner of the vehicle 10. The information that can identify the vehicle 10 includes, for example, the vehicle 10 identification (vehicle ID), the vehicle type, the model, or the color. The information that can identify the components with which the vehicle 10 is equipped, for example, the component identification information (component ID), the serial number, the model number, the part information or the color. The information about the owner of the vehicle 10 is the owner's identification (owner ID), the name, the address, or the owner's primary automobile dealer or the other information. The identification information such as the vehicle ID, the component ID, the owner ID, etc. may be uniquely dispensed by the server 20, for example. The information on the vehicle 10 may include information other than the above-described information.

The controller 25 includes at least one processor. The processor may be, for example, a general purpose processor such as a CPU, a dedicated processor that is dedicated to specific processing, or the like. The controller 25 is not limited to a processor and may include at least one dedicated circuit. The dedicated circuit may be, for example, an FPGA or an ASIC. The controller 25 controls the above-described components such as the communication interface 21, the output interface 22, the input interface 23, and the memory 24 to realize the functions of the server 20, including the functions of these components.

### Operations of Vehicle Matching System

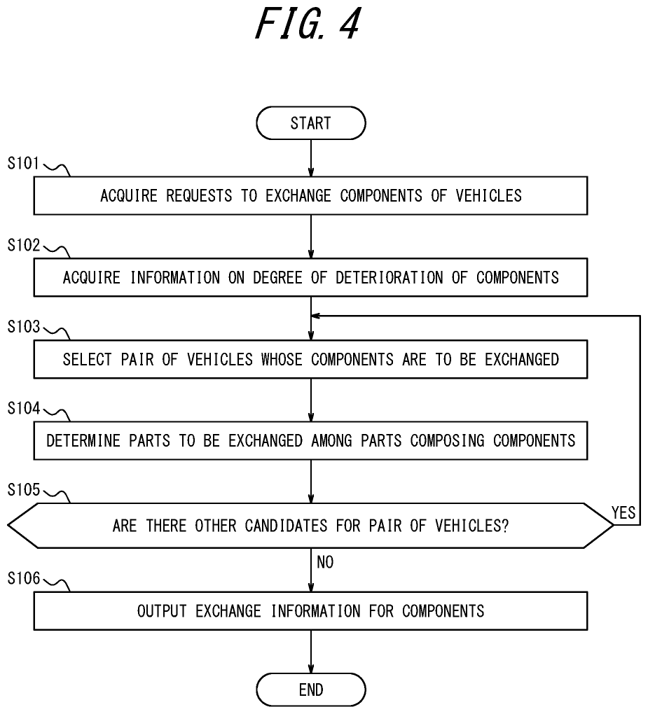

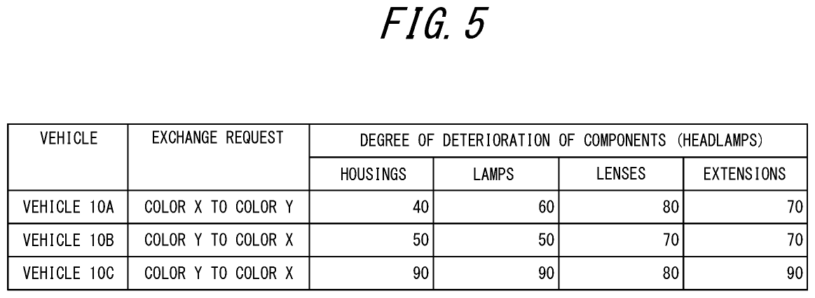

With reference to FIGS. 1, 4, and 5, operations of the vehicle matching system 1 will be described. FIG. 4 is a flowchart illustrating an operation example of the vehicle matching system 1. FIG. 5 is a table illustrating an example of degree of deterioration of components of vehicles. The flowchart in FIG. 4 illustrates the operations of the server 20 included in the vehicle matching system 1. Therefore, the description of these operations corresponds to a control method for the vehicle matching system 1, and also corresponds to a control method for the server 20 included in the vehicle matching system 1.

In this operation, as an example, it is assumed that the component to be exchanged in the vehicle matching system 1 is the headlamp. Then, this operation example describes the operation when the server 20 receives a request from the terminal apparatus 30A to exchange the headlamps of the vehicle 10A from color X to color Y.

In describing this operation, it is assumed that the server 20 has previously stored the information on the vehicles 10A, 10B, and 10C in the memory 24. It is also assumed that the server 20 has previously received a request from the terminal apparatus 30B to exchange the headlamps of the vehicle 10B and a request from the terminal apparatus 30C to exchange the headlamps of the vehicle 10C, respectively. Assume that the request to exchange the headlamps of the vehicle 10B and the request to exchange the headlamps of the vehicle 10C are the requests to exchange the headlamp color from color Y to color X, respectively.

With reference to FIG. 4, in Step S101, the controller 25 of the server 20 acquires the request to exchange the components of the vehicle 10.

The request to exchange a component of the vehicle 10 includes, for example, the information that can identify the vehicle 10, the component, or the exchange details.

In this operation example, the controller 25 of the server 20 acquires, via the communication interface 21, a request from the terminal apparatus 30A to exchange the headlamps of the vehicle 10A from color X to color Y. The request includes the identification of the vehicle 10A, the serial number of the headlamp, and a request to exchange color X with color Y. The controller 25 may associate the received request with the identification of the vehicle 10A and store it in the memory 24. The controller 25 also acquires in advance a request to exchange the headlamps of the vehicle 10B from color Y to color X and a request to exchange the headlamps of the vehicle 10C from color Y to color X.

In step S102, the controller 25 of the server 20 acquires the degree of deterioration of the components with which the vehicle 10 is equipped.

The “degree of deterioration” of a component is an indicator of the state of the component as it changes with use of the component. When a component consists of multiple parts, the degree of deterioration of the components may include the degree of deterioration of each of parts that compose the component.

In this disclosure, as an example, the degree of deterioration of the components shall be represented by an index that decreases with use of the component. For example, the degree of deterioration of the components can be expressed as a number from 0 to 100, with 100 being the value at the initial state of the component and 0 being the value at the limit state of the component. However, the durability of a component may be expressed in terms of an index that increases with use of the component. The index of the degree of deterioration may be different for each parts that composes the component.

Any method can be employed to acquire the degree of deterioration of the components. For example, the degree of deterioration of the components could be acquired based on the information acquired automatically in the vehicle 10. The controller 14 of the vehicle 10 acquires, via the acquisition interface 12, the information on the degree of deterioration of the components with which the vehicle 10 is equipped, and transmits the acquired information to the server 20 via the communication interface 11. The controller 25 of the server 20 acquires, via the communication interface 21, the information from the vehicle 10 regarding the degree of deterioration of the components with which the vehicle 10 is equipped.

For example, the degree of deterioration can be acquired based on the information measured or evaluated by the automobile dealer's workers during maintenance or inspection of the vehicle 10. When the terminal apparatus 30 accepts an input operation to input information on the degree of deterioration of the components with which the vehicle 10 is equipped, it transmits the input information to the server 20. The controller 25 of the server 20 acquires the information on the degree of deterioration of the components with which the vehicle 10 is equipped from the terminal apparatus 30 via the communication interface 21.

The controller 25 of the server 20 may acquire the information on the degree of deterioration of the components with which the vehicle 10 is equipped or the terminal apparatus 30 as it is, as the degree of degradation of the components attached to the vehicle 10. Alternatively, the controller 25 of the server 20 may perform a predetermined calculation process (conversion to a numerical value from 0 to 100 as described above) and then acquire the value as the degree of deterioration of the components attached to the vehicle 10. The controller 25 of the server 20 may store the acquired degree of deterioration of the components with which the vehicle 10 is equipped in the memory 24 in association with the identification of the vehicle 10.

In this operation example, the controller 25 of the server 20 receives, via the communication interface 21, the information from the vehicle 10A or the terminal apparatus 30A on the degree of deterioration of the headlamps with which the vehicle 10A is equipped. The information on the degree of deterioration of headlamps is, for example, the number of times the headlamps are turned on and off, the illumination level of the lights, the total mileage of the vehicle, the clarity of the lens, and the presence of scratches. Based on the information received on the degree of deterioration of the headlamps, the controller 25 calculates the degree of deterioration of the components with which the vehicle 10A is equipped as illustrated in FIG. 5, using a numerical value from 0 to 100. In FIG. 5, the degree of deterioration of the parts including the housings, the lamps, the lenses, and the extensions, which compose the headlamps, components of the vehicle 10, is represented. However, the degree of deterioration of the components may include the information itself about the degree of deterioration of the headlamps, such as the light illumination level or lens transparency, transmitted from the vehicle 10A or the terminal apparatus 30A. As illustrated in FIG. 5, the controller 25 also acquires the degree of deterioration of the headlamps of the vehicle 10B and the headlamps of the vehicle 10C in advance.

Referring again to FIG. 4, in step S103, the controller 25 of the server 20 selects a pair of vehicles 10 to exchange the components based on the request to exchange the components of the vehicles 10.

In this operation example, the controller 25 of the server 20 selects a vehicle 10 to be paired with the vehicle 10A based on a request to exchange the headlamps of the vehicle 10A from color X to color Y. For example, the controller 25 can select the vehicle 10B, which has a registered request to exchange the headlamps from color Y to color X, as the vehicle 10 to be paired with the vehicle 10A, as illustrated in FIG. 5.

Referring again to FIG. 4, in step S104, the controller 25 of the server 20 determines the second parts to be exchanged in the pair of the vehicles 10 among the first parts composing the components, based on the degree of deterioration of the components. Hereafter, the parts that compose the components are also referred to simply as the first parts, and the parts among them that are to be exchanged are also referred to simply as the second parts.

Any method can be employed to determine the second parts to be exchanged among the components. For example, the controller 25 of the server 20 may determine whether the difference in the degree of deterioration of the first parts between each vehicle 10 in the pair is within the first threshold range. The controller 25 may also use the first parts as the second parts if the difference in the degree of deterioration of the first parts between each of the vehicle 10 in the pair is determined to be within the first threshold range. This reduces unfairness among users when exchanging components of the vehicle 10.

In this operation example, the first threshold range is defined as a difference in the degree of deterioration within 10. Referring to FIG. 5, the controller 25 of the server 20 compares the degree of deterioration of each parts of the headlamps of the vehicles 10A and 10B, and determines that all four of the first parts of the housing, lamp, lens, and extension that make up the headlamp All of the four first parts (housing, lamp, lens, and extension) are determined to be the second parts to be exchanged.

However, the first threshold range may be arbitrarily defined according to the characteristics of the components or the parts, the level of service, etc. In the operation example described above, the first threshold range is set to a single range that is uniform for the components, but the first threshold range may be different for each parts of the components. For example, the controller 25 of server 20 may not include a lens as a second parts if the difference in lens transparency between the vehicles 10A and 10B is not within a predetermined threshold range. The controller 25 may not include a light in the second parts if the difference in light illumination levels between the vehicles 10A and 10B is not within a predetermined threshold range. This allows for a detailed evaluation of differences in the degree of deterioration of the components among the 10 vehicles, further reducing the sense of unfairness among users when exchanging the components of the 10 vehicles.

When determining the second parts in step S104, the controller 25 of the server 20 may determine whether the degree of deterioration of the first parts composing the component exceeds the second threshold value. When the controller 25 determines that the degree of deterioration of the first parts exceeds the second threshold value, it may determine the first parts to be parts that are to be exchanged with new parts. The controller 25 does not have to include the first parts determined to be parts that are to be exchanged with new parts in the second parts. This reduces the risk of malfunctions, etc., to the user with whom the components of the vehicles 10 are exchanged due to the exchange.

In this operation example, the second threshold value is set at the degree of deterioration level of 40 or less. In this operation example, the degree of deterioration of the components is expressed as an index that decreases with use of the component, so that if the degree of deterioration falls below 40, the degree of deterioration is considered to exceed the second threshold value. Referring to FIG. 5, the controller 25 of the server 20 determines, among the parts of the headlamps of the vehicle 10A, the housings to be parts that are to be exchanged with new parts. As a result, the controller 25 determines that the three parts (lamp, lens, and extension) are the second parts to be exchanged between the vehicles 10A and 10B, without including the housing as second parts.

Referring again to FIG. 4, in step S105, the controller 25 of the server 20 may determine whether there are other candidates for a pair of vehicles 10 based on a request to exchange the components of the vehicle 10. Specifically, the controller 25 determines, based on the request to exchange the components of the vehicle 10A, whether there are other candidates for the vehicle 10 whose components can be exchanged with the vehicle 10A. If the controller 25 determines that there are other candidates for a pair of vehicles 10 (S105-YES), the process of steps S103 and S104 is repeated for the number of candidate for the vehicles 10 whose components can be exchanged with the vehicle 10A.

In this operation example, the controller 25 of the server 20 acquires a request to exchange the headlamp color of the vehicle 10C from color Y to color X, in addition to the vehicle 10B. Therefore, the controller 25 performs steps S103 and S104 for the vehicle 10C. As a result, as illustrated in FIG. 5, the controller 25 of the server 20 compares the degree of deterioration of each part of the headlamps of the vehicles 10A and 10C and determines that only the extension is the second parts among the first parts comprising the headlamps.

Referring again to FIG. 4, in step S105, if the controller 25 of the server 20 determines that there are no other candidates for a pair of vehicles 10 (S105-NO), it selects a pair of vehicles 10 and proceeds to step S106.

In step S105, if there are multiple candidate pairs of vehicles 10 to exchange components, the controller 25 of the server 20 may select a pair of vehicles 10 to exchange the components from the multiple candidate pairs by any method. For example, the controller 25 may select pairs of vehicles 10 so that the number of second parts to be exchanged in a pair is greater. This reduces unfairness among users when exchanging the components of the vehicle 10. For example, the controller 25 may select a pair of vehicles 10 based on whether the second parts to be exchanged in the pair includes essential parts. For example, if the color of the headlamps is determined by the extensions, the controller 25 may select the extensions as mandatory parts and the extensions as second parts in the vehicle 10 pair. However, in addition to/substitute for the above example, the controller 25 may select a pair of vehicles 10 to exchange the components from a plurality of candidate pairs based on arbitrary information, such as the distance between automobile dealers used by the owners of the paired vehicles 10. This can improve the success of matching between users when exchanging the components.

In this operation example, the pair of the vehicles 10A and 10B has three second parts, the pair of the vehicles 10A and 10C has one second part, and the second part in any pair includes an extension. Therefore, the controller 25 of the server 20 selects the vehicle 10A and vehicle 10B as the pair of the vehicles 10 to exchange the headlamps.

With reference again to FIG. 4, in Step S106, the controller 25 of the server 20 outputs exchange information for the components. The exchange information for the components includes information on the pair of the vehicles 10 for which the component is to be exchanged and the second parts to be exchanged. However, in addition to the information described above, the exchange information for the components may include any information, such as information on the parts that are to be exchanged with new parts.

Any method can be employed to output the exchange information. The controller 25 of the server 20 may output the exchange information via the output interface 22, such as a display. Alternatively, the controller 25 may transmit the exchange information to the terminal apparatus 30 via the communication interface 21. In such a case, the terminal apparatus 30 can output the exchange information received from the server 20 on a display or the like.

In this operation example, as headlamp exchange information, the information on the vehicle 10A and the vehicle 10B, that the lamp, lens and extension are to be exchanged among the headlamp parts, and that the housing of the vehicle 10A should be exchanged with new parts are output. The user of the vehicle matching service can decide whether or not to exchange the components based on the exchange information for the components.

As described above, the computer, which is the server 20 in the present embodiment, acquires requests to exchange the components of the vehicle 10, as well as the degree of deterioration of the components with which the vehicle 10 is equipped. The computer selects pairs of vehicles 10 to exchange the components based on the aforementioned request. The computer determines the second parts to be exchanged in a pair of vehicles 10 among the first parts composing the component based on the degree of deterioration.

According to this configuration, when matching users who wish to exchange the components of the vehicles 10, the degree of deterioration of the components with which the respective vehicles 10 are equipped is taken into account to determine which of the parts composing the components is to be exchanged, thereby reducing the sense of unfairness among users when exchanging components and thereby improving the degree of success of matching. Thus, the present embodiment improves the usefulness of the service for matching users who wish to exchange components of the vehicle 10 with each other.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which a general purpose computer functions as the server 20 according to the above embodiment can also be implemented. Specifically, a program in which processes for realizing the functions of the server 20 according to the above embodiment are written may be stored in a memory of a general purpose computer, and the program may be read and executed by a processor. Accordingly, the present disclosure can also be implemented as a program executable by a processor, or a non-transitory computer readable medium storing the program. Examples of the non-transitory computer readable medium include a magnetic storage device, an optical disc, a magneto-optical storage device, and a semiconductor memory.

For example, in the embodiments described above, the components of the vehicle 10 are described as being headlamps. For example, the components of the vehicle 10 may be a car seat consisting of parts such as a head, backrest, and seat, or a tire/wheel consisting of parts such as a tire, wheel, and wheel cover.

For example, in the embodiment described above, the server 20 is described as acquiring information on the degree of deterioration of the components of the vehicle 10 after acquiring a request to exchange the components of the vehicle 10. but this is not the case. For example, the server 20 may acquire information on the degree of deterioration of the components of the vehicle 10 in advance, with or without a request.

1. A computer comprising a controller configured to:
acquire requests to exchange components of vehicles;
acquire degree of deterioration of the components with which the vehicles are equipped;
select a pair of vehicles whose components are to be exchanged based on the requests; and
determine second parts to be exchanged in the pair among first parts composing the components based on the degree of deterioration.

2. The computer according to claim 1, wherein the controller is configured to determine the first parts to be the second parts in a case in which a difference in degree of deterioration of the first parts between the vehicles in the pair is determined to be within a first threshold range.

3. The computer according to claim 1, wherein the controller is configured to select the pair of the vehicles to have a greater number of the second parts.

4. The computer according to claim 1, wherein the controller is configured to determine the first parts to be parts that are to be exchanged with new parts in a case in which degree of deterioration of the first parts is determined to exceed a second threshold value.

5. The computer according to claim 1, wherein the controller is configured to output exchange information for the components, the exchange information including information on the pair of the vehicles and information on the second parts to be exchanged.
